(19) United States
(12) Patent Application Publication
(10) Pub. No.: US 2008/0060485 A1
(43) Pub. Date: Mar. 13, 2008

(54) Wrench with H-shaped handle

(76) Inventor: Chih-Ching Hsieh, Fengyuan City (TW)

Correspondence Address: PHILLIP LIU, 6980, WHITEOAK DR., RICHMOND, BC, V7EAZ9, CA

(21) Appl. No.: 11/979,973

(22) Filed: Nov. 13, 2007

Related U.S. Application Data
(63) Continuation-in-part of application No. 11/480,951, filed on Jul. 6, 2006.

(51) Int. Cl. B25B 23/16

(52) U.S. Cl. 81/177.1

(57) ABSTRACT

A wrench includes an H-shaped handle with an open end and a box end connected two ends of the handle. The handle includes two elongate recessed areas defined in two wide sides thereof and each of the two recessed areas extends to two respective root portions of the open end and the box end. A width is 3 to 4 times of a thickness of the flat surface. A thickness of each of the open end and box end is the same as a thickness of the handle. The wrench is light in weight and the function ends can be easily inserted to a narrow space.

### FIELD OF THE INVENTION

This is a Continuation-in-Part application of Applicant's former patent application Ser. No. 11/480,951, filed on Jul. 06, 2006.

### BACKGROUND OF THE INVENTION

A conventional wrench 90 is shown in FIG. 7 and generally includes a handle 91 which has an open end 93 and a box end 92 on two ends of the handle 91. The open end 93 and the box end 92 are obviously thicker than the thickness of the handle 91 so that they might not be inserted into a narrow space to reach the object to be tightened or loosened. Besides, the thick handle 91 and the even thicker open end 93 and box end 92 make the wrench to be heavy and costly.

The user usually carries multiple wrenches 90 with different sizes and shapes for the open end 93 and the box end 92. Although the handle 91 includes an elongate recess defined in at least one side thereof so as to reduce the weight of the wrench 90, the area that the recess covers cannot make the wrench 90 to be light enough.

The present invention intends to provide a wrench that has an H-shaped handle and two function ends which have the same thickness as the handle so that the wrench is light in weight and can be easily inserted into a narrow space.

The handle includes an elongate recessed area defined in each side thereof and the recessed area extends to the root portion of the box end and the open end so as to make the handle to be light as possible.

### SUMMARY OF THE INVENTION

The present invention relates to a wrench which comprises a handle and an open end is connected to an end of the handle. Two elongate recessed areas are defined in two wide sides of the handle so as to reduce weight of the handle. A width is 3 to 4 times of a thickness of the flat surface. A thickness of the open end is the same as a thickness of the handle. The elongate recessed area in each wide side of the handle extends to a root portion of the box end and the open end of the wrench.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the wrench of the present invention;

FIG. 2 is a plain view of the wrench of the present invention;

FIG. 3 is a side cross sectional view along A-A line in FIG. 2 of the wrench of the present invention;

FIG. 4 is a cross sectional view to show a cross sectional view of the handle;

FIG. 5 shows that a user holds the handle of the wrench to operate a bolt;

FIG. 6 shows that the open end of the wrench of the present invention is inserted into a narrow space to reach a bolt, and

FIG. 7 shows a conventional wrench.

### DETAILED DESCRIPTION OF THE PREFERRED EMBODIMENT

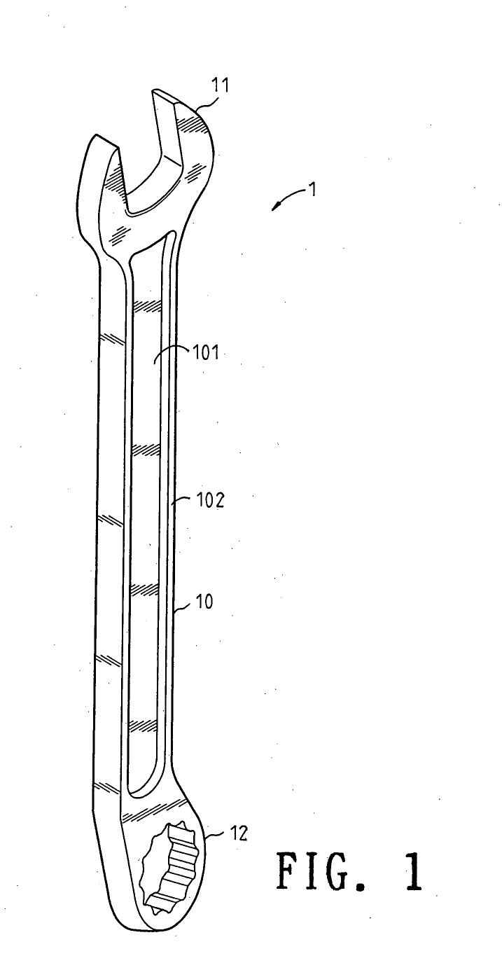

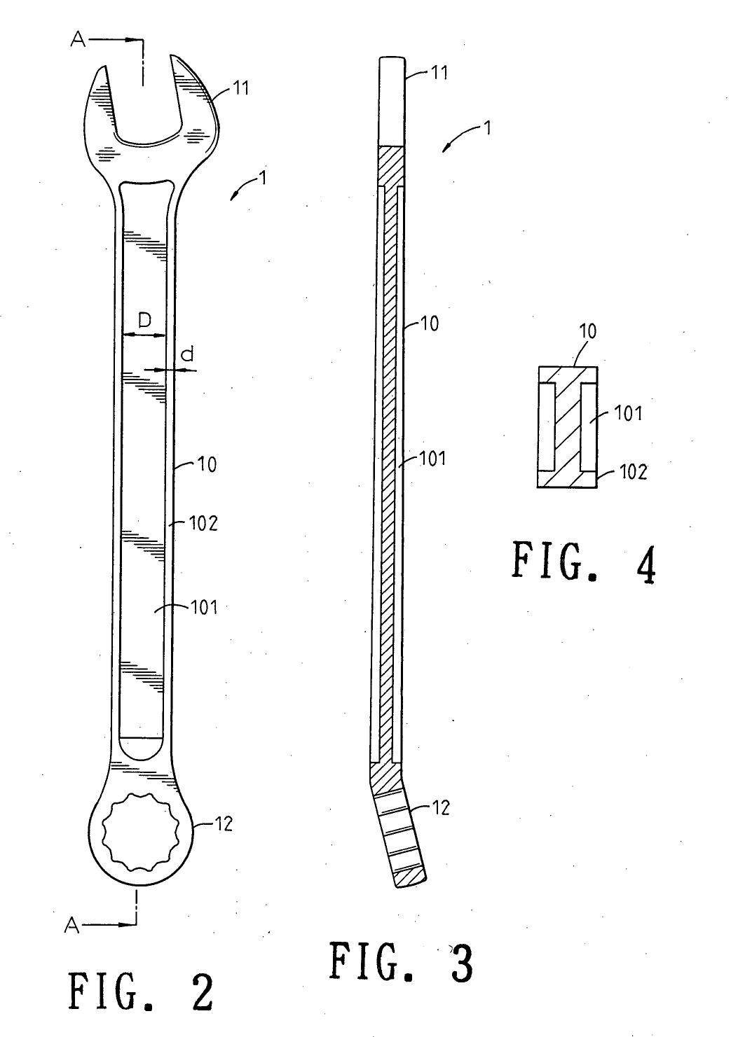

Referring to FIGS. 1 to 4, the wrench 1 of the present invention comprises a handle 10, an open end 11 and a box end 12 are respectively connected to two ends of the handle 10. The handle 10 is a rectangular and flat handle which includes two parallel and narrow sides and two parallel and wide sides which are perpendicular to the narrow sides. Two elongate recessed areas 101 are defined in two wide sides of the handle 10 and each recessed area 101 is defined by two flat surfaces 102 which form two walls on two sides of the recessed area 101. Each recessed areas 101 is located at a central portion of each wide side of the handle 10. The open end 11 and the box end 12 on two ends of the handle 10 each include a root portion which is connected to the handle 10 and includes two gradually wider profile connected to the two narrow sides of the handle 10 when viewed from FIG. 2. Each of the elongate recessed areas 101 extends to the root portion of each of the open end 11 and the box end 12. By this arrangement, the elongate recessed areas 101 stretch to its maximum length and therefore reduce weight of the wrench 10 effectively.

The handle 10 has an even thickness except for the recessed areas 101. A width “D” is 3 to 4 times of a width “d” of the flat surface 102. A thickness of each of the recessed areas 101 is a quarter of a thickness of the handle 10. A thickness of the open end 11 and the box end 12 is the same as a thickness of the handle 10. The box end 12 extends an angle, such as 15 degrees, relative to a longitudinal axis of the handle 10.

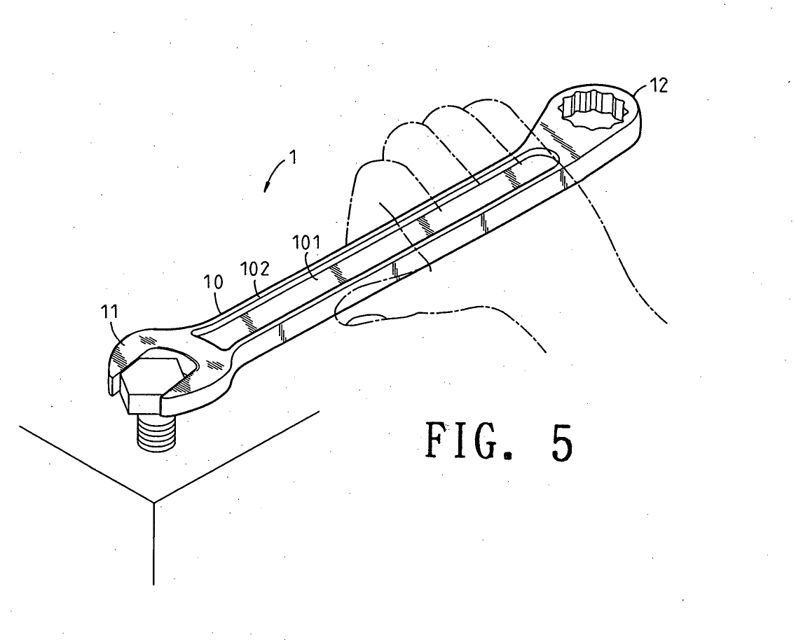

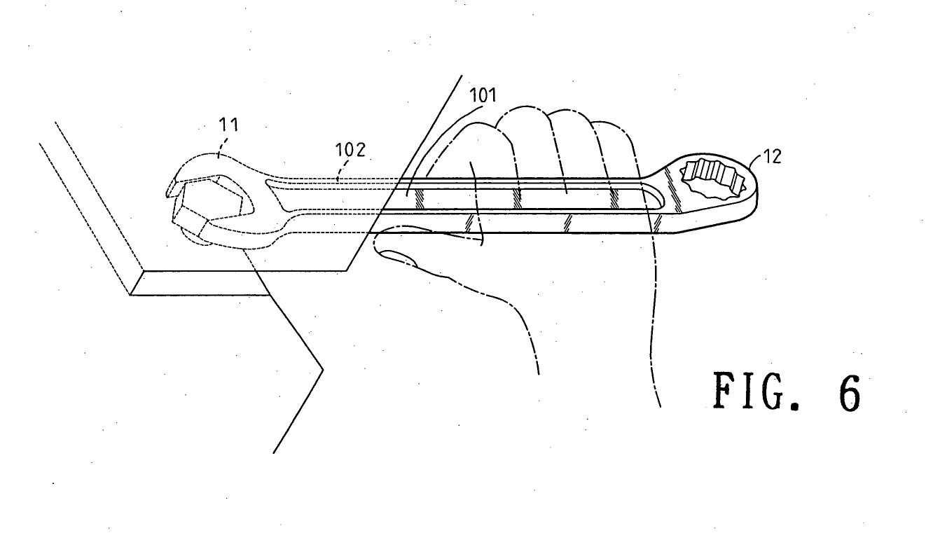

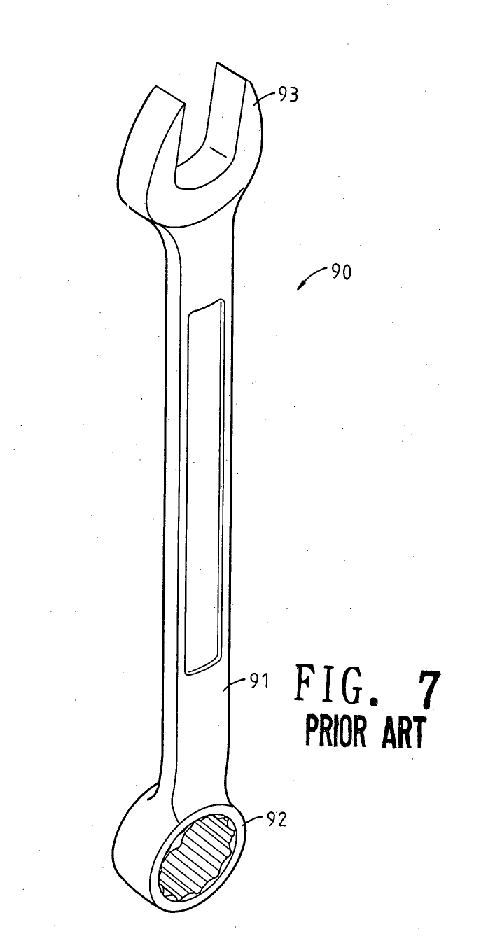

As shown in FIGS. 5 and 6, the wrench 1 is light in weight because of the recessed areas 101 in the two wide sides of the handle 10 extend to the two respective root portions of the open end 11 and the box end 12. Besides, because the open end 11 and the box end 12 of the handle 10 have the same thickness as the handle 10, the open end 11 or the box end 12 can be easily inserted into a narrow space to reach the bolt as shown in FIG. 6.

The handle 10 of the wrench 1 of the present invention is strong enough to bear torque when the user applies torque to the bolt and the recessed areas 101 make the wrench to be light in weight and use less material.

While we have shown and described the embodiment in accordance with the present invention, it should be clear to those skilled in the art that further embodiments may be made without departing from the scope of the present invention.

What is claimed is:

1. A wrench comprising:
a handle being a rectangular and flat handle, the handle including two narrow sides and two wide sides which are perpendicular to the narrow sides, an open end and a box end connected to two ends of the handle respectively, two recessed areas defined in two wide sides of the handle so as to form two flat surfaces which form two walls on sides of each of the recessed areas, a width of the recessed area being 3 to 4 times of a width of the flat surface, a thickness of each of the open end an the box end being the same as a thickness of the handle, the open end and the box end on the two ends of the handle each including a root portion which includes two gradually wider profile connected to the two narrow sides of the handle, each of the two recessed areas extending to two respective root portions of the open end and the box end.

2. The wrench as claimed in claim 1, wherein the recessed area is located at a central portion of the handle.

3. The wrench as claimed in claim 1, wherein the box end extends an angle relative to a longitudinal axis of the handle.

4. The wrench as claimed in claim 1, wherein a thickness of the recessed area is a quarter of a thickness of the handle.
